(19) United States
(12) Patent Application Publication
(10) Pub. No.: US 2016/0328083 A1
(43) Pub. Date: Nov. 10, 2016

(54) TOUCH SCREEN SYSTEM

(71) Applicant: Xiaoyu Zhang, Shenzhen (CN)

(72) Inventor: Xiaoyu Zhang, Shenzhen (CN)

(73) Assignee: AAC Technologies Pte. Ltd., Singapore City (SG)

(21) Appl. No.: 15/001,933

(22) Filed: Jan. 20, 2016

(30) Foreign Application Priority Data
May 7, 2015 (CN) 201510230464.6

(51) Int. Cl. G06F 3/041

(52) U.S. Cl. CPC G06F 3/0418; G06F 3/0412

(57) ABSTRACT

A touch screen system is disclosed in the present disclosure. The touch screen system includes a control circuit module, a touch display assembly, an area selection module, and an instruction module. The touch display assembly includes a touch display panel and a touch sensor disposed under the touch display panel, the touch display panel includes a peripheral region defined as a non-touch display region, and the touch sensor includes a peripheral portion corresponding to the non-touch display region of the touch display panel. The area selection module is configured for selecting an actual area of the non-touch display region; and the instruction module is configured for providing an instruction to the control circuit module according to area selection of the area selection module, and instructing the control circuit module to deactivate a touch sensing function of the peripheral portion of the touch sensor.

### FIELD OF THE DISCLOSURE

The present disclosure generally relates to touch screen technologies, and more particularly, to a touch screen system capable of reducing undesired operation.

### BACKGROUND

Touch screens, especially capacitive touch screens with multi-touch capability, are widely used in electronic devices such as smart phones, tablet computers, or the like. To meet users' requirement of large size screens, most of the touch screens are designed to have narrow edges. However, the narrow edges may cause a peripheral region of the touch screen to be mistakenly touched by the user's finger when the electronic device is held by the user's hand. This may result in an undesired operation and bring inconvenience to the user.

Therefore, it is desired to provide a new touch screen system which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic planar view of a touch panel of a touch screen system according to an embodiment of the present disclosure.

FIG. 2 is a block diagram of a touch screen system according to an embodiment of the present disclosure.

### DETAILED DESCRIPTION

The present disclosure will be described in detail below with reference to the attached drawings and the embodiment thereof.

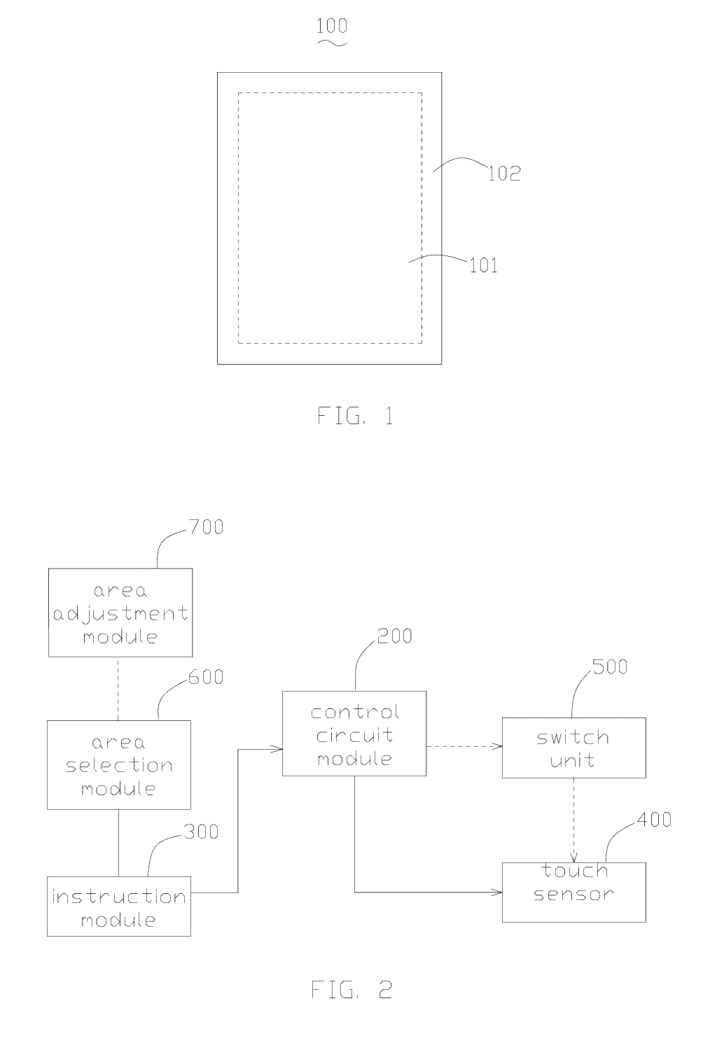

Referring to FIGS. 1-2, a touch screen system according to an embodiment of the present disclosure is shown. The touch screen system may be applied in an electronic device such as a smart phone, a tablet computer, or the like. The touch screen system includes a control circuit module 200 and a touch display assembly; the touch display assembly includes a touch display panel 100 (as illustrated in FIG. 1), and a touch sensor 400 (as illustrated in FIG. 2) which is disposed under the touch display panel 100.

The touch display panel 100 includes a main central region which is defined as a main touch display region 101, and a peripheral region which is defined as a non-touch display region 102; the non-touch display region 102 surrounds the main touch display region 101. The touch sensor 400 spreads out evenly under the touch display panel 100, and also includes a main sensing portion corresponding to the main touch display region 101 and a peripheral portion corresponding to the non-touch display region 102.

It should be noted that the definition of the main touch display region 101 and the non-touch display region 102 is merely regional division in the touch panel 100, no space or blank exists between the main touch display region 101 and the non-touch display region 102. In operation, the main touch display region 101 and the non-touch display region 102 cooperate with each other to display images or other contents on the touch screen system.

Moreover, the non-touch display region 102 may optionally be selectable, that is, an actual area of the non-touch display region 102 may be selected as needed. The area selection of the non-touch display region 102 may be realized by a software program which is implemented by a processor connected to the control circuit module 200 within the electronic device.

For example, in the present embodiment, the touch screen system further includes an area selection module 600 and an instruction module 300, both of which are software modules. The area selection module 600 is configured for selecting an actual area of the non-touch display region 102 when being activated, and the instruction module 300 is configured for providing an instruction to the control circuit module 200 according to the area selection of the area selection module 600, so as to instruct the control circuit module 200 to control the touch sensor 400 to deactivate a touch sensing function of the peripheral portion of the touch sensor 400, which corresponds to the non-touch display region 102 of the touch display panel 100.

In addition, the instruction module 300 may also determine whether a touch action applied onto the non-touch display region 102 exceeds a predetermined time, if so, the instruction 300 may determine that the touch action is a mistaken operation performed by the user, and accordingly provide the instruction to the control circuit module 200 for controlling the peripheral portion of the touch sensor 400 to be deactivated.

Furthermore, the non-touch display region 102 may optionally be adjustable, in other words, the actual area of the non-touch display region 102 may be adjusted as needed. The area adjustment of the non-touch display region 102 may also be realized by the software program, for example, the touch screen system may further include an area adjustment module 700 which is also a software module. The area adjustment module 600 is configured for adjusting a size of the non-touch display region 102 before the actual area of the non-touch display region 102 being selected.

For example, the area adjustment module 600 may include a control unit for providing a first control signal for broadening the non-touch display region 102 or a second control signal for narrowing the non-touch display region 102, a broadening unit for implementing broadening of the non-touch display region 102 according to the first control signal, and a narrowing unit for implementing narrowing of the non-touch display region 102 according to the second control signal.

When the touch sensing function of the peripheral of the touch sensor 400 is deactivated under control of the control circuit module 200, any touch action applied onto the non-touch display region 102 is treated as an invalid input command. In this situation, the non-touch display region 102 is equivalent to being untouchable.

In one embodiment, the control circuit module 200 may be electrically connected to the peripheral portion of the touch sensor 400, and the control circuit module 200 can directly control the deactivation of the touch sensing function of the peripheral portion of the touch sensor 400.

Alternatively, in another embodiment, as shown in FIG. 2, the control circuit module 200 may control the deactivation of the touch sensing function of the peripheral portion of the touch sensor 400 via a switch unit 500, and the switch unit 500 is electrically connected between the control circuit module 200 and the peripheral portion of the touch sensor 400. With this configuration, when the control circuit module 200 receives the instruction from the instruction module 300, the control circuit module 200 may control the switch unit 200 to be turned off, so that the touch sensing function of the peripheral portion of the touch sensor 400 is deactivated.

In the touch screen system as provided in the present disclosure, the peripheral portion of the touch sensor 400 corresponding to the peripheral region (i.e., non-touch display region 102) of the touch display panel 100 is controlled to be deactivated by an instruction, therefore, the user's mistaken touch on the peripheral region of the touch display panel 100 can be ignored and the undesired operation due to the mistaken touch can be reduced accordingly.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A touch screen system, comprising:
a control circuit module;
a touch display assembly connected to the control circuit module, the touch display assembly comprising a touch display panel and a touch sensor disposed under the touch display panel, the touch display panel comprising a peripheral region defined as a non-touch display region, and the touch sensor comprising a peripheral portion corresponding to the non-touch display region of the touch display panel;
an area selection module for selecting an actual area of the non-touch display region; and
an instruction module for providing an instruction to the control circuit module according to area selection of the area selection module, and instructing the control circuit module to deactivate a touch sensing function of the peripheral portion of the touch sensor.

2. The touch screen system of claim 1, wherein the touch display panel further comprises a main touch display region, the non-touch display region surrounds the main touch display region.

3. The touch screen system of claim 2, wherein the main touch display region and the non-touch display region cooperate with each other to display images or contents, and no space or blank exists between the main touch display region and the non-touch display region.

4. The touch screen system of claim 1, wherein the instruction module is further configured for determining whether a touch action applied onto the non-touch display region exceeds a predetermined time, and if so, determining that the touch action is a mistaken operation performed by the user and providing the instruction to the control circuit module for controlling the peripheral portion of the touch sensor to be deactivated.

5. The touch screen system of claim 1, wherein the non-touch display region of the touch display panel is adjustable.

6. The touch screen system of claim 5, further comprising an area adjustment module for adjusting a size of the non-touch display region before the actual area of the non-touch display region being selected.

7. The touch screen system of claim 6, wherein the area adjustment module comprises a control unit for providing a first control signal for broadening the non-touch display region or a second control signal for narrowing the non-touch display region, a broadening unit for implementing broadening of the non-touch display region according to the first control signal, and a narrowing unit for implementing narrowing of the non-touch display region according to the second control signal.

8. The touch screen system of claim 1, wherein the control circuit module is electrically connected to the touch sensor; the control circuit module directly deactivates of the touch sensing function of the peripheral portion of the touch sensor.

9. The touch screen system of claim 1, wherein the control circuit module deactivates the touch sensing function of the peripheral portion of the touch sensor via a switch unit; the switch unit is electrically connected between the control circuit module and the peripheral portion of the touch sensor.

10. A touch screen system, comprising:
a control circuit module;
a touch display assembly connected to the control circuit module, the touch display assembly comprising a touch display panel and a touch sensor disposed under the touch display panel, the touch display panel comprising a peripheral region defined as a non-touch display region, and the touch sensor comprising a peripheral portion corresponding to the non-touch display region of the touch display panel; and
a processor configured for selecting an actual area of the non-touch display region, providing an instruction to the control circuit module according to area selection to instruct the control circuit module to deactivate a touch sensing function of the peripheral portion of the touch sensor.

11. The touch screen system of claim 10, wherein the processor is further configured for determining whether a touch action applied onto the non-touch display region exceeds a predetermined time, and if so, determining that the touch action is a mistaken operation performed by the user and providing the instruction to the control circuit module for controlling the peripheral portion of the touch sensor to be deactivated.

12. The touch screen system of claim 10, wherein the non-touch display region of the touch display panel is adjustable.

13. The touch screen system of claim 12, the processor is further configured for adjusting a size of the non-touch display region before the actual area of the non-touch display region being selected.

14. The touch screen system of claim 10, wherein the control circuit module is electrically connected to the touch sensor; the control circuit module directly deactivates of the touch sensing function of the peripheral portion of the touch sensor.

15. The touch screen system of claim 10, wherein the control circuit module deactivates the touch sensing function of the peripheral portion of the touch sensor via a switch unit; the switch unit is electrically connected between the control circuit module and the peripheral portion of the touch sensor.
